(19) United States
(12) Patent Application Publication
(10) Pub. No.: US 2013/0258484 A1
(43) Pub. Date: Oct. 3, 2013

(54) SYSTEM FOR CONTROLLING ACTIVE WINDOWS WITH GLARE SENSOR

(71) Applicant: David Nicolas, Paris (FR)

(72) Inventor: David Nicolas, Paris (FR)

(73) Assignee: Saint-Gobain Glass France, Courbevoie (FR)

(21) Appl. No.: 13/995,045

(22) PCT Filed: Dec. 14, 2011
(86) PCT No.: PCT/FR2011/052979

§ 371 Date: Jun. 17, 2013

(30) Foreign Application Priority Data
Dec. 16, 2010 (FR) 1060627

(51) Int. Cl. G02B 1/11

(52) U.S. Cl. CPC G02B 1/11
USPC 359/601

(57) ABSTRACT

The present invention relates to a system for controlling the optical transmission of a plurality of windows Vₖ with electro-controllable optical transmission properties, comprising at least one spatial brightness sensor for supplying at least one value representative of brightness respectively for different spatial areas forming subsets Xᵢ of a set X and thus supplying a mapping L of a brightness in which the subsets Lᵢ of L are associated with the sets Xᵢ, and a control unit comprising a memory in which programs are stored which are capable of controlling the optical transmission of each of said windows.

The programs are capable of defining a mapping A of spatial areas Aⱼ of glare from the mapping L of brightness, of using a mapping O of spatial areas Oₘ with electro-controllable brightness, each subset Oₘ being associated with one or more of said windows Vₖ with electro-controllable optical transmission, and of controlling the optical transmission of each of said windows Vₖ with electro-controllable optical transmission as a function of A and of O.

The present invention relates to the field of controlling brightness inside buildings.

The windows of the buildings have the drawback of contributing to the heating of the buildings in summer and to their cooling in winter.

Since the mid-1990s, a wide variety of insulating and solar control windows have been developed by the glass industry. With the “low emissive” or “reflecting” coatings that are now on the market, high thermal insulation and solar protection levels can be obtained.

Nevertheless, these windows have fixed properties which cannot be adapted to the temperature and sunlight conditions.

Windows with electro-controllable optical transmission address this issue.

These so-called “intelligent” windows have optical properties that can be modified electrically.

The article entitled “Effect of switchable glazing on discomfort glare from windows”, Building Environment 44 (2009) p. 1171-1180 discusses the possibility of using an electrochrome window to reduce the glare.

Nevertheless, the reduction of the glare experienced by a user in a room of a building provided with such windows is not always satisfactory in real conditions.

One aim of the present invention is to provide a system for controlling a plurality of windows with electro-controllable optical transmission to control the transmission through the windows of a building and ensure a good management of the glare resulting from the light passing through the windows or from the light diffused or reflected in the room.

According to one aspect of the present invention, the system for controlling the optical transmission of a plurality of active windows Vₖ with electro-controllable optical transmission properties comprises:
at least one spatial brightness sensor for supplying at least one value representative of brightness respectively for different spatial areas forming subsets Xᵢ of a set X and thus supplying a mapping L of brightness in which the subsets Lᵢ of L are associated with the sets Xᵢ; and
a control unit comprising a memory in which programs are stored which are capable of controlling the optical transmission of each of said windows, said programs being capable of:
defining a mapping A of spatial areas Aⱼ of glare from the mapping L of brightness;

using a mapping O of spatial areas Oₘ with electro-controllable brightness, each subset Oₘ being associated with one or more of said active windows Vₖ;
controlling the optical transmission of each of said active windows Vₖ as a function of A and of O.

According to particular embodiments, the system comprises one or more of the following features, taken in isolation or in all technically possible combinations:
the subsets Aⱼ of the set A are values representative of spatial areas with strong brightness, strong contrast, or strong brightness and strong contrast;
said spatial areas with strong brightness, strong contrast, or strong brightness and strong contrast are each determined in relation to one and the same absolute reference level which is predetermined or calculated;
the subsets Aⱼ of A correspond to spatial areas for which a value representative of brightness is greater than or equal to LI with LI being a predetermined or calculated value representative of brightness;
the subsets Aⱼ of A correspond to spatial areas in which the ratio of value representative of brightness with an adjacent spatial area is greater than or equal to CI with CI being a predetermined or calculated value representative of contrast;
the mapping O and the subsets Oᵢ are representative of spatial areas in which the brightness is controlled directly or indirectly by one or more of said electro-controllable windows;
said programs are capable of controlling the optical transmission of each of said active windows Vₖ as a function also of information concerning the relative influence of each active window Vₖ on the value representative of brightness of each spatial area Oₘ, for example a coefficient assigned to each window Vₖ for each area Oₘ;
said programs are capable of obtaining said information automatically;
said information is obtained by the simultaneous and asynchronous variation of a plurality or of all of said active windows Vₖ;
the asynchronous variation consists in periodically varying the optical transmission of said active windows Vₖ with periods of length that are different or offset in time;
a number or each of said active windows Vₖ are controlled individually;
said active windows Vₖ are windows of one and the same room of a building, the different spatial areas concerning the room of the building.

The subject of the invention is also an assembly comprising a plurality of active windows Vₖ with electro-controllable optical transmission properties and a system for controlling the optical transmission of said windows Vₖ, in which the control system is as described above.

Also the subject of the invention is a method for controlling the optical transmission of a plurality of active windows Vₖ with electro-controllable optical transmission properties, comprising steps consisting in:
using at least one spatial brightness sensor to supply at least one value representative of brightness respectively Lᵢ=L(Xᵢ) for different spatial areas Xᵢ of a set X and thus supply a mapping L of brightness in which the sets Lᵢ are associated with the sets Xᵢ;
defining a mapping A of spatial areas Aⱼ of glare from the mapping L of brightness;
using a mapping O of spatial areas Oₘ with electro-controllable brightness, each subset Oₘ being associated with one or more of said active windows Vₖ;
controlling the optical transmission of each of said active windows Vₖ as a function of A and of O.

According to particular embodiments, the method offers one or more of the following features, taken in isolation or in all technically possible combinations:
the subsets Aⱼ of the set A are values representative of spatial areas with strong brightness, strong contrast, or strong brightness and strong contrast;
said spatial areas with strong brightness, strong contrast, or strong brightness and strong contrast are each determined in relation to one and the same absolute reference level which is predetermined or calculated;
the subsets Aⱼ of A correspond to spatial areas for which a value representative of brightness is greater than or equal to LI with LI being a predetermined or calculated value representative of brightness;
the subsets Aⱼ of A correspond to spatial areas in which the ratio of value representative of brightness with an adjacent spatial area is greater than or equal to CI with CI being a predetermined or calculated value representative of contrast;
the mapping O and the subsets Oᵢ are representative of spatial areas in which the brightness is controlled directly or indirectly by one or more of said electro-controllable windows;
the optical transmission of each of said active windows Vₖ is controlled as a function also of information concerning the relative influence of each active window Vₖ on the value representative of brightness of each spatial area Oₘ, for example a coefficient assigned to each window Vₖ for each area Oₘ;
said information is obtained automatically;
said information is obtained by the simultaneous and asynchronous variation of a plurality or of all of said active windows Vₖ;
the asynchronous variation consists in periodically varying the optical transmission of said active windows Vₖ with periods of length that are different or offset in time;
a number or each of said active windows Vₖ are controlled individually;
said active windows Vₖ are windows of one and the same room of a building, the different spatial areas concerning the room of the building.

The invention will be better understood from reading the following description, given solely as an example, and by referring to the appended drawing in which:

FIG. 1 is a functional diagram of a control system; and

FIGS. 2 to 5 are diagrams illustrating, respectively, a spatial grid X, a mapping of brightness L, a mapping of glare A and a mapping O.

The control system 1 that is represented is intended to manage both the visual comfort of users present in a room of a building and the heat regulation of the room.

The room is equipped with a number of active windows Vₖ with electro-controllable optical transmission properties that the control system 1 is capable of controlling.

The system 1 described relates to a single room but, more generally, the control system 1 can control the lighting of a number of rooms of a building.

The active windows Vₖ are, for example, windows that include an electrochemically active device that reacts chemically to the application of an electrical power supply, such as electrochrome windows. The optical transmission of such a window is thus controlled electrically.

The expression “optical domain” should be understood to mean the visible, infrared and ultraviolet domains.

There are numerous electrochrome windows.

These are generally classified in three categories: “all-organic” or “all-polymer”, “mixed”, that is to say both organic and inorganic, and “all-solid”, that is to say generally all inorganic.

U.S. Pat. No. 5,239,406 and EP-A-0 612 826 describe, for example, organic electrochrome devices.

EP-0 253 713 and EP-0 670 346, EP-0 382 623, EP-0 518 754 or EP-0 532 408 describe mixed electrochrome devices.

EP-0 831 360 and WO-A-00/03290 describe all-solid electrochrome devices.

Advantageously, the electrochemically active device is a so-called “all-solid” device. Such a device offers the advantage of being durable, since it comprises inorganic layers. Such a device also offers the advantage of making it possible to minimize the number of substrates, the layers being deposited on a single substrate.

However, the active windows Vₖ are not necessarily electrochrome. They are, generally, active windows with electro-controllable optical transmission properties, for example gazochrome windows or even thermochrome windows if the material is heated electrically.

The control system 1 comprises:
at least one spatial brightness sensor 2 for supplying a mapping L of brightness; and
a control unit 10 comprising a memory 12 in which programs are stored which are capable of controlling the optical transmission of each of the windows Vₖ.

In order to manage the glare, the spatial brightness sensor 2 is capable of supplying at least one value representative of brightness respectively for different spatial areas forming subsets Xᵢ of a set X and thus supplying a mapping L of brightness in which the subsets Lᵢ of L are associated with the sets Xᵢ.

It should be noted that the term “value” should be understood throughout the text in the broad sense. It is a value of any appropriate type. It is, for example, a single numerical value, or a set of values such as a vector or a matrix.

The term “representative” should be understood to mean that this value makes it possible to obtain information on the brightness, the glare, the temperature. It is, for example, a value of intensity or of voltage of an electrical current.

The brightness sensor is, for example, a CCD camera. It is, for example, turned toward the workspace of a user.

FIG. 2 illustrates a spatial grid X.

The grid X represents all the space taken into account by the control unit to manage the glare affecting users.

The following for example applies:

X={(x,y)εR²Infx≦x≦Supx and Infy≦y≦Supy}.

The grid X has, for example, a rectangular contour corresponding to the viewing window of the brightness sensor, this rectangle being in this example subdivided into separate rectangles Xᵢ.

As a variant, the subdivision of X is of any suitable type. The subdivision is, for example, non-uniform. A greater density of subsets Xᵢ is, for example, provided for in certain areas.

Generally, the subdivision is, for example, made in such a way that the Xᵢ are separate and that ∪Xᵢ=X.

Each Xᵢ corresponds for example to a set of pixels of the camera 2.

The areas Xᵢ are, for example, relatively large, for example squares with a side of between 1 and 10 centimeters of the area viewed.

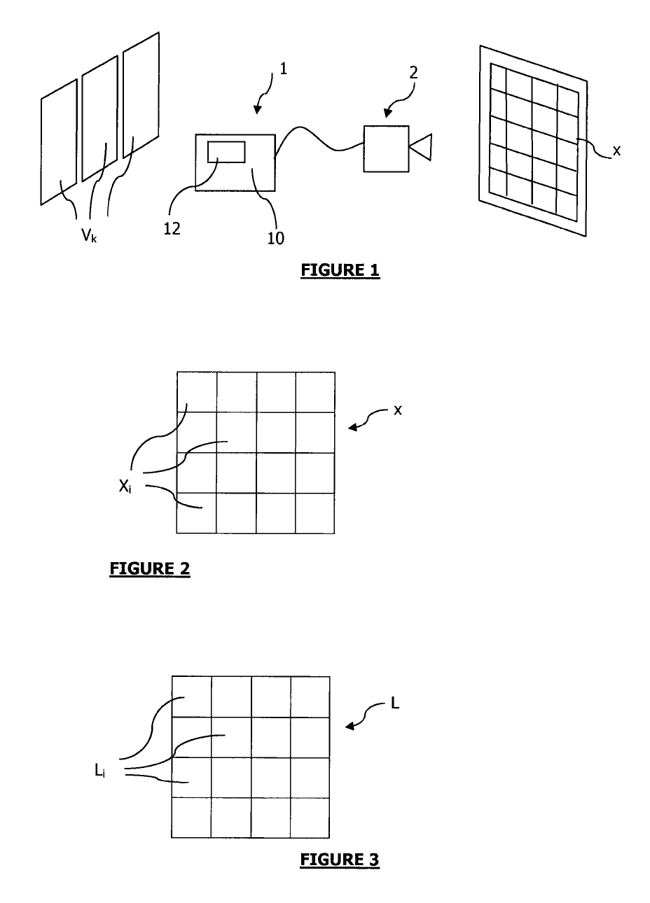

The mapping L supplied by the brightness sensor is illustrated in FIG. 3.

In this example, Lᵢ=(L(Xᵢ),Xᵢ) with L(Xᵢ) being the average brightness measured (for example in lux) by the spatial brightness sensor 2. L(Xᵢ) is, for example, obtained by averaging the value obtained for each pixel of the sensor 2 located in the spatial area Xᵢ.

The mapping L, which is a set, is the combination of the sets Lᵢ.

It should be noted that the mappings are “virtual” in the sense that they are not intended to be viewed. They are therefore tables of values in the values mapped are associated with spatial values.

The term “mapping” should thus be understood to mean a set in which at least one particular value (for example of brightness) is associated with at least one spatial value, the association being, for example, made by a pointer to a memory allocation of the spatial value, and, generally, by a logical link of any appropriate type.

The programs of the control unit are also capable of defining a mapping A of spatial areas Aⱼ of glare from the mapping L of brightness.

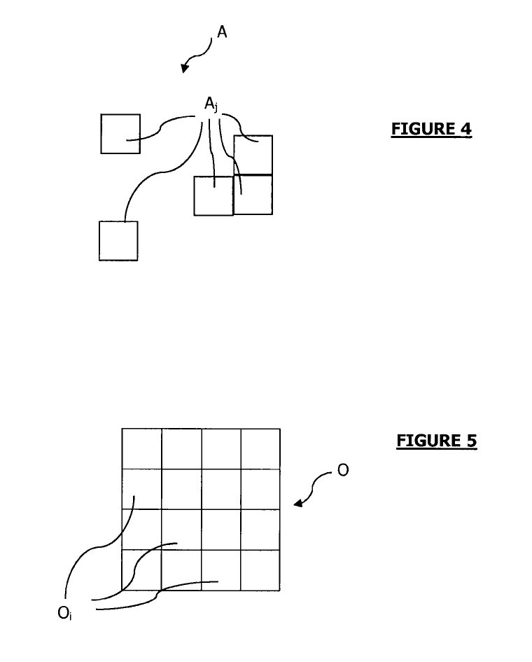

FIG. 4 illustrates a mapping A obtained by selecting from the sets Lᵢ those for which the brightness value L(Xᵢ) is greater than or equal to a predetermined value.

Thus, in this example, A={Lᵢ/L(Xᵢ)≧LI}, being a brightness value.

LI is, for example, a predetermined value stored in memory. LI may also be a value calculated by the control programs, for example as a function of the average brightness in the spatial grid X.

The subsets Aⱼ of the set A are thus values representative of spatial areas with strong brightness.

As a variant, the mapping of glare A corresponds to spatial areas with strong contrast, or strong brightness and strong contrast.

The areas with strong contrast are, for example, obtained by comparing the brightness value L(Xᵢ) of an area Xᵢ with the brightness value L(Xⱼ) of one or more areas Xⱼ adjacent to the area Xᵢ.

The following, for example, applies:

A={L₁/∃j/d(Xᵢ,Xⱼ)≦D and/L(Xᵢ)−L(Xⱼ)/≧CI},

d(Xᵢ,Xⱼ) being the distance between the areas Xᵢ and Xⱼ and CI being a contrast value (in this case, a brightness difference value).

The comparison between L(Xᵢ) and L(Xⱼ) is of any appropriate type. It is, for example, the ratio of brightness

$$\frac{L ( {X}_{i} )}{L ( {X}_{j} )}$$

which is calculated and compared to CI, rather than the brightness difference.

In the same way as for LI, CI is, for example, a predetermined value stored in memory. LI may also be a value calculated by the control programs, for example as a function of the average brightness in the spatial grid X.

The control programs are also capable of using a mapping O of spatial areas Oₘ with electro-controllable brightness, each subset Oₘ being associated with one or more of said windows Vₖ with electro-controllable optical transmission.

FIG. 5 illustrates a mapping O.

The subsets Oₘ are, for example, defined by:

$${O}_{i} = \{ {( {a}_{i} )}_{k} ∈ {R}^{k} / L ( {X}_{i} ) = {\sum }_{k} {a}_{k} T ( {V}_{k} ) \}$$

with T(Vₖ) being the light transmission of each window Vₖ.

A subset Oᵢ corresponds in this case to each spatial area Xᵢ. Each subset Oᵢ then gives information relating to the influence of each window Vₖ on the brightness of the spatial area Xᵢ.

As a variant however, the Oₘ do not each correspond to an area Xᵢ but, for example, to a set of a number of areas Xᵢ.

It should be noted that the coefficients (aᵢ)ₖ are not necessarily constants and may be a function of parameters such as, for example, the position of the sun in the sky, which is, for example, determined by means of a clock.

The coefficients (aᵢ)ₖ may be predetermined. In a simple case, they are, for example, a vector of k digits having the value 0 or 1, only one of them having, for example, the value 1.

The coefficients (aᵢ)ₖ may also be measured, in a preliminary calibration phase or during normal operation of the windows.

For this, the transmission is, for example, modified successively by the control unit for each window Vₖ.

The measurement of the brightness of each spatial area Xᵢ and the known variation of transmission of the window Vₖ makes it possible to calculate the coefficient a_{i,k} for each Xᵢ, and to reiterate the calculation for each window Vₖ.

Another, faster, solution consists in simultaneously varying the transmission of all the windows Vₖ, but with an identifiable different variation for each window Vₖ.

The transmission of each window Vₖ is, for example, varied according to the law:

T(Vₖ)=TL₀+b·cos(wₖ·t)

with TL₀, b and wₖ being constants, t being the time, T(Vₖ) being the light transmission of the window Vₖ, the constants wₖ all having different values for each window Vₖ.

The control programs are also capable of controlling the light transmission T(Vₖ) of each of said windows Vₖ with electro-controllable optical transmission as a function of A and of O.

To this end, the transmission of the windows Vₖ is, for example, modified such that A becomes the null set.

This result can, for example, be obtained iteratively after a latency time measured with a clock.

If A remains non-null, the windows Vₖ are, for example, all controlled in their colored state.

It should be noted that the control system 1 may also be dedicated to managing the light transmission of the windows as a function of the temperature in the room or of the general brightness in the room, even if the glare is then managed preferably as a priority.

The CCD camera may also, for example, serve as a sensor for measuring the overall brightness in the room, for example by averaging the brightness of each area Xᵢ.

Furthermore, it goes without saying that the system may comprise one or more sensors of each type.

A presence sensor may also be provided or, as a variant, replaced by a clock, the presence in a room then being likened to a predetermined time band. The control system 1 manages, for example, the glare and the brightness as a priority in the presence of a user in the room and the temperature as a priority in the absence of any user.

It should be noted that the term “user” should be understood to mean a user of the room of the building.

Finally, the room may also be equipped with blackout means such as blinds, curtains, LCD windows, etc., the control system being capable of controlling these blackout means.

1. A system (1) for controlling the optical transmission of a plurality of active windows Vₖ with electro-controllable optical transmission properties, comprising:
at least one spatial brightness sensor for supplying at least one value representative of brightness respectively for different spatial areas forming subsets Xᵢ of a set X and thus supplying a mapping L of brightness in which the subsets Lᵢ of L are associated with the sets Xᵢ;
a control unit comprising a memory in which programs are stored which are capable of controlling the optical transmission of each of said windows; said programs being capable of:
defining a mapping A of spatial areas Aⱼ of glare from the mapping L of brightness;
using a mapping O of spatial areas Oₘ with electro-controllable brightness, each subset Oₘ being associated with one or more of said active windows Vₖ;
controlling the optical transmission of each of said active windows Vₖ as a function of A and of O.

2. The system (1) as claimed in claim 1, in which the subsets Aⱼ of the set A are values representative of spatial areas with strong brightness, strong contrast, or strong brightness and strong contrast.

3. The system (1) as claimed in claim 1, in which said spatial areas with strong brightness, strong contrast, or strong brightness and strong contrast are each determined in relation to one and the same absolute reference level which is predetermined or calculated.

4. The system (1) as claimed in claim 3, in which the subsets Aⱼ of A correspond to spatial areas for which a value representative of brightness is greater than or equal to LI with LI being a predetermined or calculated value representative of brightness.

5. The system (1) as claimed in claim 3, in which the subsets Aⱼ of A correspond to spatial areas in which the ratio of value representative of brightness with an adjacent spatial area is greater than or equal to CI with CI being a predetermined or calculated value representative of contrast.

6. The system (1) as claimed in claim 1, in which the mapping O and the subsets Oᵢ are representative of spatial areas in which the brightness is controlled directly or indirectly by one or more of said electro-controllable windows.

7. The system (1) as claimed in claim 1, in which said programs are capable of controlling the optical transmission of each of said active windows Vₖ as a function also of information concerning the relative influence of each active window Vₖ on the value representative of brightness of each spatial area Oₘ, for example a coefficient assigned to each window Vₖ for each area Oₘ.

8. The system (1) as claimed in claim 7, in which said programs are capable of obtaining said information automatically.

9. The system (1) as claimed in claim 8, in which said information is obtained by the simultaneous and asynchronous variation of a plurality or of all of said active windows Vₖ.

10. The system (1) as claimed in claim 9, in which the asynchronous variation consists in periodically varying the optical transmission of said active windows Vₖ with periods of length that are different or offset in time.

11. The system as claimed in claim 1, in which a number or each of said active windows Vₖ are controlled individually.

12. The system as claimed in claim 1, in which said active windows Vₖ are windows of one and the same room of a building, the different spatial areas concerning the room of the building.

13. An assembly comprising a plurality of active windows Vₖ with electro-controllable optical transmission properties and a system for controlling the optical transmission of said windows Vₖ, in which the control system is as claimed in claim 1.

14. A building comprising an assembly as claimed in claim 13, the assembly being, for example, installed in a room of the building.

15. A method for controlling the optical transmission of a plurality of active windows Vₖ with electro-controllable optical transmission properties, comprising steps consisting in:
using at least one spatial brightness sensor to supply at least one value representative of brightness respectively Lᵢ=L(Xᵢ) for different spatial areas Xᵢ of a set X and thus supply a mapping L of brightness in which the sets Lᵢ are associated with the sets Xᵢ;
defining a mapping A of spatial areas Aⱼ of glare from the mapping L of brightness;
using a mapping O of spatial areas Oₘ with electro-controllable brightness, each subset Oₘ being associated with one or more of said active windows Vₖ;
controlling the optical transmission of each of said active windows Vₖ as a function of A and of O.
